(19) United States
(12) Patent Application Publication
(10) Pub. No.: US 2024/0085027 A1
(43) Pub. Date: Mar. 14, 2024

(54) HEATING APPARATUS

(71) Applicant: LEEDARSON LIGHTING CO.,LTD., Zhangzhou (CN)

(72) Inventor: Heiwang Lee, Zhangzhou (CN)

(21) Appl. No.: 18/199,667

(22) Filed: May 19, 2023

(30) Foreign Application Priority Data
Sep. 8, 2022 (CN) 202211093932.6

(51) Int. Cl. F24C 7/08; A47J 27/00

(52) U.S. Cl. CPC F24C 7/085; A47J 27/004; F24C 7/087; A47J 2202/00

(57) ABSTRACT

The heating apparatus consists of different parts that work together to heat food. It has a bottom platform with a surface that gets hot and a heater underneath it. The heater is responsible for making the surface hot. There are also sensors in the apparatus to measure the temperature. One sensor detects the temperature of the surface, while the other sensor is on a probe that measures the temperature of the food inside a container. To make the heater work and produce heat, there is a power source. The power source provides electricity to the heater. The apparatus also has a controller that connects to the power source and the temperature sensors. The controller determines how much electricity is sent to the heater.

### FIELD

The present invention is related to a heating apparatus, and more particularly related to a heating apparatus with flexible control.

### BACKGROUND

Cooking devices driven by electricity are more and more popular in recent years for they are convenient and easy to use. For different purposes and functions, different cooking devices are developed.

For examples, electric Stove are traditional cooking appliances that consist of one or more electric heating elements on top of the stove. They are used for cooking and heating food in pots and pans.

An electric oven is a kitchen appliance used for baking, roasting, and broiling. It has heating elements at the top and bottom of the oven, and sometimes additional elements on the sides or back.

A slow cooker is a countertop appliance that is designed for long, slow cooking at low temperatures. It is ideal for preparing stews, soups, and other slow-cooked dishes.

Rice cookers are specifically designed to cook rice. They have built-in heating elements and sensors to control temperature and cooking time automatically.

Pressure cookers use steam pressure to cook food quickly. Electric pressure cookers are equipped with heating elements and electronic controls to regulate the pressure and cooking time.

Electric grills and griddles are used for indoor grilling and cooking. They have electric heating elements that heat a cooking surface, allowing you to cook meats, vegetables, and other foods.

However, most people would not have sufficient space for placing so many types of cooking devices in their home. It would be beneficial to design cooking devices with more flexible functions and make them easier to be used for preparing better food.

### SUMMARY

In some embodiments, a heating apparatus is made up of different components. It includes a bottom platform with a heating surface and a bottom heater that is responsible for heating the surface. The apparatus also features a first temperature sensor, which is positioned to detect the temperature of the heating surface. Additionally, a second temperature sensor is placed on a probe to measure the temperature of the food in a food container that is being heated by the bottom heater. A power source is provided to supply a first driving current to the bottom heater, allowing it to generate heat. A controller, connected to the power source, the first temperature sensor, and the second temperature sensor, determines the first driving current that is supplied to the bottom heater.

In some embodiments, the probe is placed within food in the container to detect food temperature. For example, the probe is placed in a hot soup or insert into a chicken meat to detect food temperature.

In some embodiments, a container cover corresponding to the container has a hole for inserting and fixing the probe to keep the probe stay within the food. The container cover provides a structure for keep the probe to collect temperature easily and conveniently.

The heating apparatus may further include a lateral heater and a surrounding wall.

In some embodiments, the lateral heater heats a surrounding wall.

The surrounding wall and the heating surface form a container space for storing the food container to emit heat from multiple directions.

The controller determines a second driving current supplied to the lateral heater to adjust a heating ratio between the lateral heater and the bottom heater.

In some embodiments, the lateral heater and the surrounding wall are removably coupled to the bottom platform.

When the lateral heater and the surrounding wall are removed from the bottom platform, food is heated above the heating surface in a first mode.

When the lateral heater and the surrounding wall are attached to the bottom platform, food is heated by both the lateral heater and the bottom heater in a second mode.

In some embodiments, the lateral heater and the bottom heater share the same power source.

The heating apparatus may further include a manual switch for changing a current ratio between the first driving current and the second driving current.

In some embodiments, the current ratio between the first driving current and the second driving current are adjusted by reference to a time schedule during cooking.

In some embodiments, when the surrounding wall and the lateral heater is detached from the bottom platform, food upon the heating surface has not lateral shielding wall.

The heating apparatus may further include a heat insulation wall.

In some embodiments, the heat insulation wall prevents heat escape from lateral direction.

In some embodiments, the heat insulation wall encloses the lateral heater.

In some embodiments, the heat insulation wall has an air path for hot air heated by the bottom heater to stay in the air path for providing heat from lateral side to a container enclosed by the heat insulation wall and the heating surface.

In some embodiments, the first temperature sensor is placed below the heating surface.

The heating apparatus may further include a third temperature sensor placed in a different position from the first temperature sensor and the second temperature sensor.

In some embodiments, the controller uses data of the first temperature sensor, the second temperature sensor and the third temperature to adjust the first driving current and the second driving current over time according to a time schedule.

In some embodiments, controller adjusts the first driving current and the second driving current so that a first position of the container has a different temperature than a second position of the container to increase convection.

The heating apparatus may further include a vibrator.

In some embodiments, the controller selectively activates the vibrator to generate a vibration to the container to shake the food in the container during food heating.

In some embodiments, the heating surface is rotated to carry the container to rotate during food heating.

In some embodiments, the vibration of the vibrator is more than 20 Hz.

In some embodiments, the controller has a wireless interface to connect to a mobile phone for receiving a cook parameter from the mobile phone.

The wireless interface is an HTTP server.

In some embodiments, a QR code label is attached to the heating apparatus.

The mobile phone scans the QR code label to connect to a remote server with a parameter of the heating apparatus.

The remote server receives a photo taken by the mobile phone for a food being cooked in the container, and transmitting a cooking parameter associated with the food in the photo to the mobile phone.

The mobile phone further transmits the cooking parameter to the controller to adjust the first driving current of the bottom heater.

### BRIEF DESCRIPTION

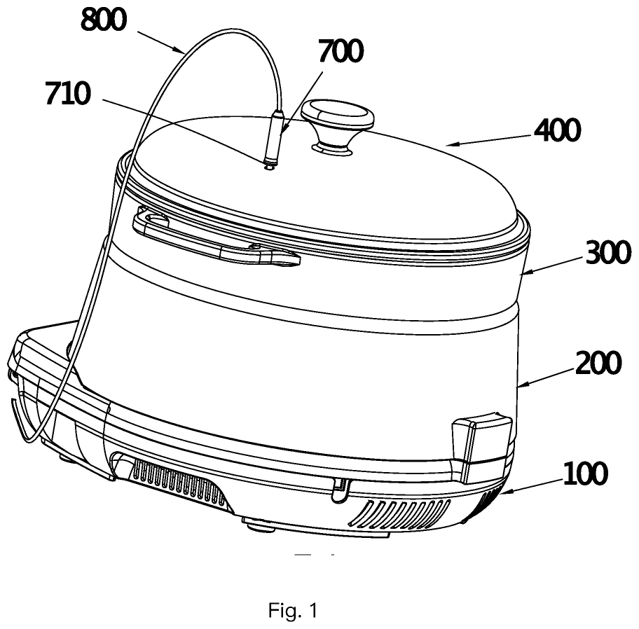

FIG. 1 illustrates a perspective view of a cooking apparatus embodiment.

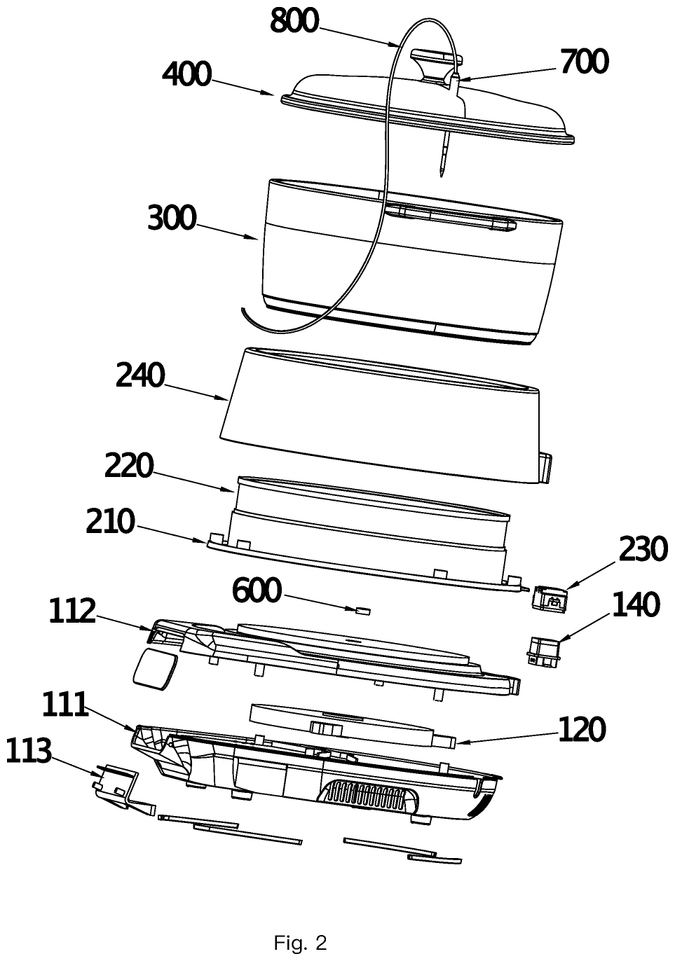

FIG. 2 illustrates an exploded view of the cooking apparatus in FIG. 1.

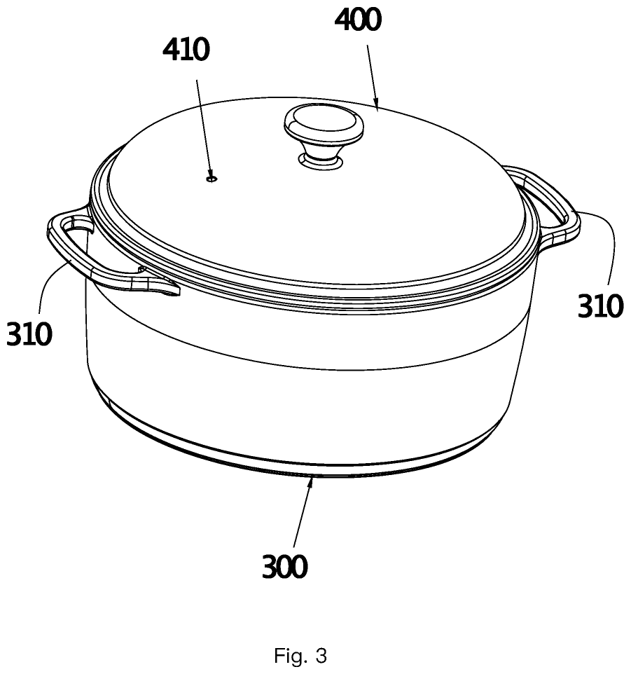

FIG. 3 illustrates a component of the embodiment in FIG. 1.

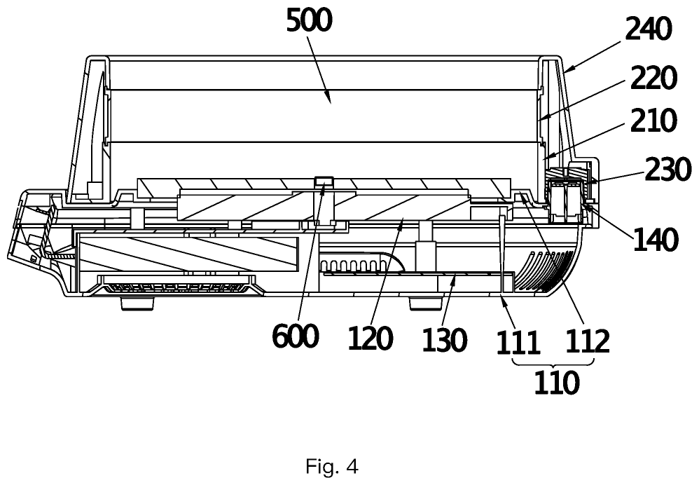

FIG. 4 illustrates a sectional view of the example in FIG. 1.

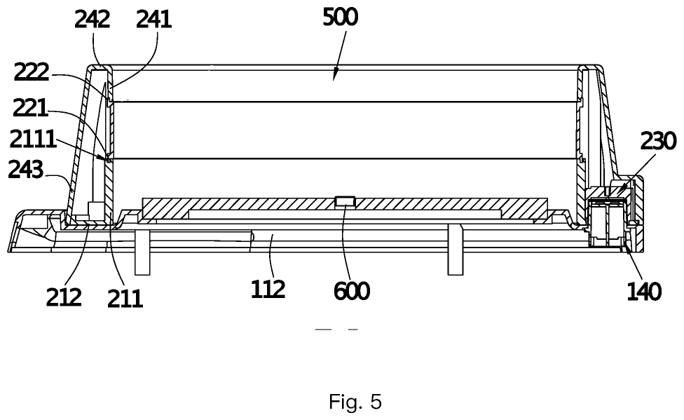

FIG. 5 illustrates another sectional view of the example in FIG. 1.

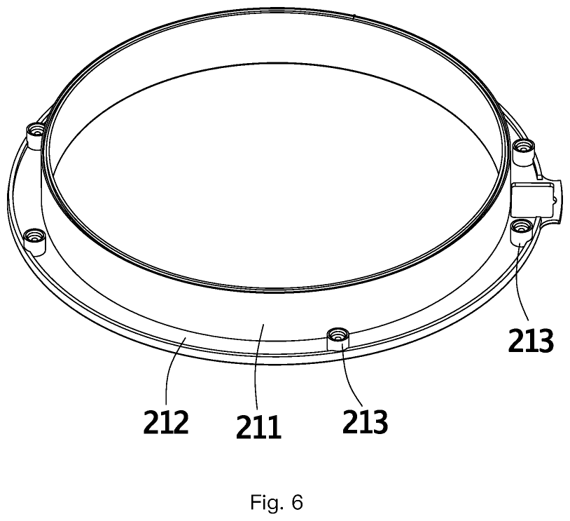

FIG. 6 illustrates an example of a heating component.

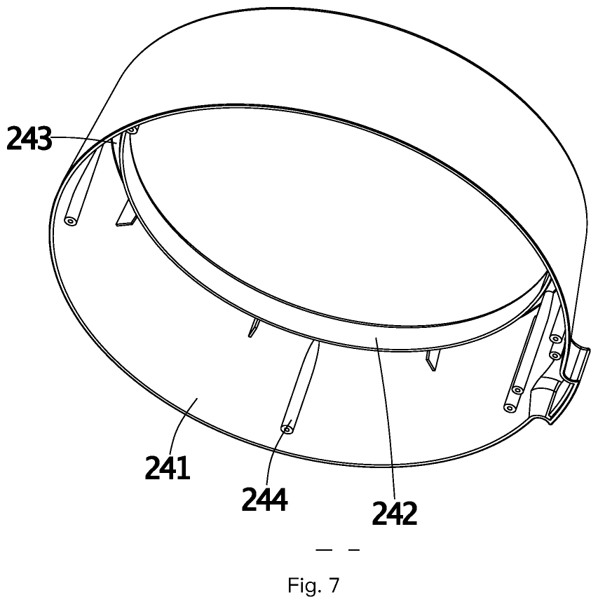

FIG. 7 illustrates an example of a heat insulation wall.

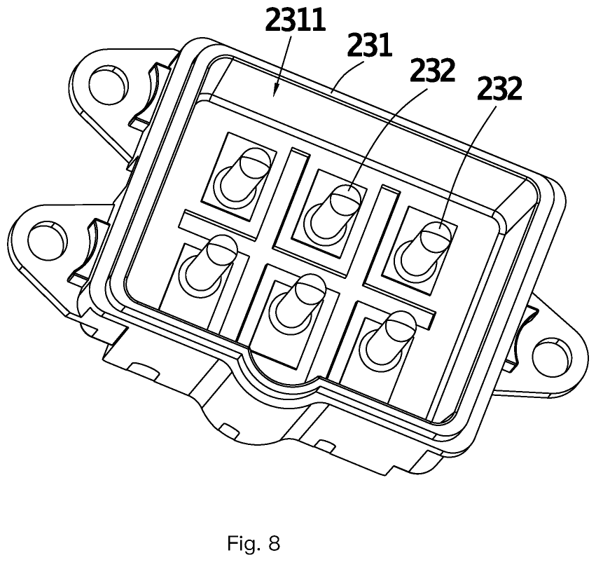

FIG. 8 illustrates an electrical connector.

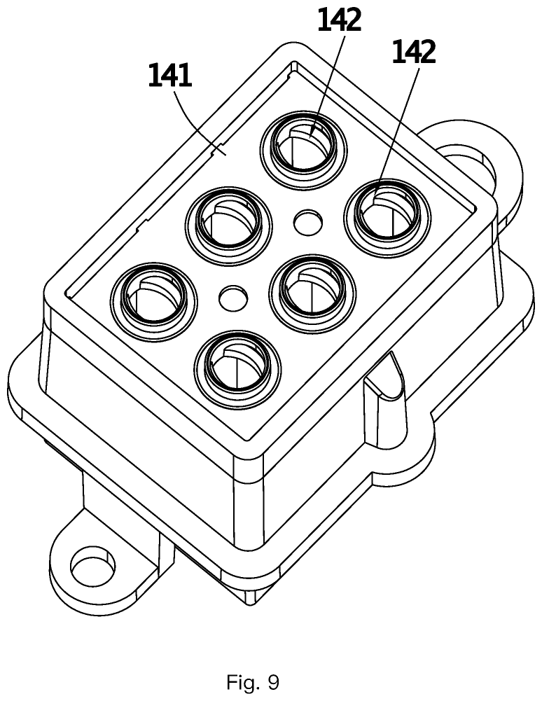

FIG. 9 illustrates another electrical connector.

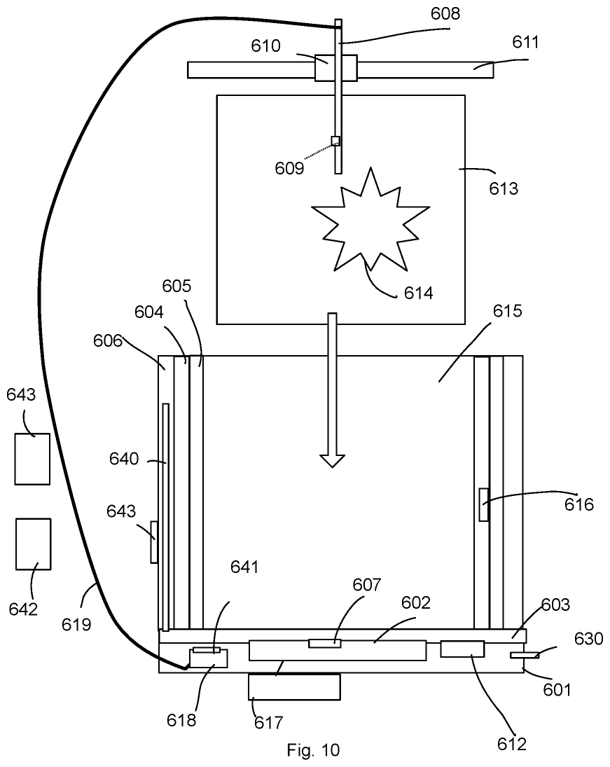

FIG. 10 illustrates a cooking apparatus example.

### DETAILED DESCRIPTION

In FIG. 10, a heating apparatus is made up of different components. It includes a bottom platform 601 with a heating surface 603 and a bottom heater 602 that is responsible for heating the surface 603. The apparatus also features a first temperature sensor 607, which is positioned to detect the temperature of the heating surface 603. Additionally, a second temperature sensor 609 is placed on a probe 608 to measure the temperature of the food 614 in a food container 613 that is being heated by the bottom heater 602. A power source 617 is provided to supply a first driving current to the bottom heater 602, allowing it to generate heat.

The driving current is not explicitly marked in the drawing because it is invisible. Person of skilled in the art would know that based on the text description, they can implement a power source that filters an indoor power source like 110V AC power to a proper DC or AC current. Certain protection circuit may also be implemented according to different technical requirement. The first driving current and the second driving current mentioned below are generated by the power source 617.

A controller 618, connected to the power source 617, the first temperature sensor 607, and the second temperature sensor 609, determines the first driving current that is supplied to the bottom heater.

In some embodiments, the probe 608 is placed within food 614 in the container 613 to detect food temperature. For example, the probe 608 is placed in a hot soup or insert into a chicken meat to detect food temperature.

In some embodiments, a container cover 611 corresponding to the container 613 has a hole 610 for inserting and fixing the probe 608 to keep the probe 608 stay within the food 614. The container cover 611 provides a structure for keep the probe 608 to collect temperature easily and conveniently.

The heating apparatus may further include a lateral heater 604 and a surrounding wall 605.

In some embodiments, the lateral heater 604 heats a surrounding wall 605, which further provide heating to the container 613.

The surrounding wall 605 and the heating surface 603 form a container space 615 for storing the food container 613 to emit heat from multiple directions, e.g. from the bottom and the lateral side of the container 613.

The controller 618 determines a second driving current supplied to the lateral heater 604 to adjust a heating ratio between the lateral heater 604 and the bottom heater 602.

In some embodiments, the lateral heater 604 and the surrounding wall 605 are removably coupled to the bottom platform 601. Some connectors may be used for couple the lateral heater 604 and the surrounding wall 605 to the bottom platform 601 while allowing the components to be detached.

When the lateral heater 604 and the surrounding wall 605 are removed from the bottom platform 601, food is heated above the heating surface 603 in a first mode.

With the spatial limitation of the surrounding wall 605, it is convenient for users to cook their food like frying an egg with proper tool easily.

When the lateral heater and the surrounding wall are attached to the bottom platform, food is heated by both the lateral heater and the bottom heater in a second mode.

In some embodiments, the lateral heater 604 and the bottom heater 603 share the same power source 617.

The heating apparatus may further include a manual switch 630, e.g. a rotation button or a touch display, for changing a current ratio between the first driving current and the second driving current. Specifically, users may select to provide more heat from lateral side instead of from the bottom or vice versa.

In some embodiments, the current ratio between the first driving current and the second driving current are adjusted by reference to a time schedule during cooking.

For example, at beginning, most heat may be generated from the bottom, but when the temperature increases to pass a threshold, more heat may be generated from the lateral side to keep the food in a better heating space, instead of focus heat providing in certain position.

In some embodiments, when the surrounding wall 605 and the lateral heater 604 is detached from the bottom platform 601, food upon the heating surface has not lateral shielding wall.

The heating apparatus may further include a heat insulation wall 606. The heat insulation wall 606 may prevent users to get hurt for the hot temperature. In addition, the heat insulation wall 606 also keep more energy not to escape easily during the cooking.

In some embodiments, the heat insulation wall 606 prevents heat escape from lateral direction.

In some embodiments, the heat insulation wall 606 encloses the lateral heater 604.

In some embodiments, the heat insulation wall 606 has an air path for hot air heated by the bottom heater to stay in the air path 640 for providing heat from lateral side to a container 613 enclosed by the heat insulation wall 606 and the heating surface 603.

The air path may provide a space for storing air that is heated by the bottom heater 602 and/or the lateral heater 604. The air is a good medium for keeping heat that is further transmitted to the container 613 to heat the food 614.

In some embodiments, the first temperature sensor 607 is placed below the heating surface 603.

The heating apparatus may further include a third temperature sensor 616 placed in a different position from the first temperature sensor 607 and the second temperature sensor 609. With multiple temperature values from different positions, the controller 618 may implement better heat control.

In some embodiments, the controller 618 uses data of the first temperature sensor 607, the second temperature sensor 609 and the third temperature 616 to adjust the first driving current and the second driving current over time according to a time schedule.

In some embodiments, the controller 618 adjusts the first driving current and the second driving current so that a first position of the container has a different temperature than a second position of the container to increase convection. This may be deliberately designed to enhance a steady heating for the food, particularly for soup or noodle cooking.

The heating apparatus may further include a vibrator 612. Vibrator 612 may include a motor and related structure to create shaking motions.

In some embodiments, the controller selectively activates the vibrator 612 to generate a vibration to the container to shake the food in the container during food heating. It provides magic effect particularly in soup or some food processing. The vibration during heating makes the particles in the food to move in random directions, making them to interact more frequently to make the food more delicious.

In some embodiments, the heating surface is rotated to carry the container to rotate during food heating.

In some embodiments, the vibration of the vibrator is more than 20 Hz. For example, 30 Hz-60 Hz may be particularly helpful on cooking chicken or meat during experiments.

In some embodiments, the controller 618 has a wireless interface to connect to a mobile phone 642 for receiving a cook parameter from the mobile phone 642.

The wireless interface 641 is an HTTP server. Specifically, the controller 618 provides a HTTP server with a web page to provide to the mobile phone 642 to view with a common web browser like Safari or Chrome. The web page serves as an interface that is easily to be created, edited and provides flexible control of the controller 618 via the mobile phone 642.

In some embodiments, a QR code label 643 is attached to the heating apparatus.

The mobile phone 642 scans the QR code label 643 to connect to a remote server with a parameter of the heating apparatus. Manufactures or third party company when receiving the HTML request, they may read the parameter in the link.

For example, if the QR code records a link like https://cookdevice.com/ask?pottype=123abc. The remote server may get the pot type as ‘123abc’. A corresponding parameter or tutorial may be provided to the mobile phone 642. In addition, connection method, e.g. Bluetooth ID/passwords may also be provided via the web page from the remote server.

Users may also take photos for the food they are processing. The remote server 643 receives a photo taken by the mobile phone 642 for a food being cooked in the container, and transmitting a cooking parameter associated with the food in the photo to the mobile phone 642. For example, the remote server 643 may use AI algorithm to recognize the food amount and type in the photo. Based on the cooking apparatus parameter, a control parameter may be provided to the user via their mobile phones 642 to help the users to control the controller 618 easily.

The mobile phone 642 further transmits the cooking parameter to the controller 618 to adjust the first driving current of the bottom heater 602.

Please refer to FIG. 1. In FIG. 1, a cooking apparatus includes a container cover 600. A second temperature sensor 700 inserted through the container cover 400, which has a stop structure 710 to keep the second temperature sensor 700 not to fall directly into the food.

There is a connecting wire 800 to transmitting temperature data detected by the second temperature sensor 700. There is a pot container 300 inserted to a holder bracket 200. The holder bracket 200 is mounted above a bottom platform 100.

The following drawings show different aspects of the example in FIG. 1. For components with the same reference numerals among different drawings, they refer to the same components. If they are described above, they may not be repeated again for brevity.

In FIG. 2, in addition to what are explained above, the cooking apparatus has a lateral heater 220 with a connector 210. Electrical connector 230 and electrical connector 140 are used for providing electrical connection from a power source to the lateral heater 220. They are detachable as mentioned above. There is a first temperature sensor 600. A bottom heater 120 provides heat from the bottom side. A heating surface 112 receives heat from the bottom heater 120 is placed on a bottom housing 111. There is a storage container for storing the wires and other components.

In FIG. 3, a hole 410 on the container cover 400 is used for inserting the probe that contains the second temperature sensor. There are holding structures 310 for users to hold the container 300.

In FIG. 4, a container space 500 is used for placing the food container mentioned above. There is a heat insulation wall 240 for enclosing the lateral heater 220 placed on a lateral connector 210, 230.

The bottom housing 111 and the bottom part 112 form the bottom part 110. There is a control circuit 130 and the storage 120 for performing the function mentioned above.

The first temperature sensor 600 is used for detecting temperature from the bottom side.

FIG. 5 further shows the installation brackets 211, 212, installation rings 222, 230, 243, the installation housing 2111, the pressing rings 2411, 241, and other components mentioned above.

FIG. 6 shows the bracket 211 with other components 213, 2112.

FIG. 7 shows the heat insulation wall and its components 241, 242, 243, 244 as structure connectors to connect to the main body of the heating apparatus.

FIG. 8 shows an electrical connector 231 that has plug pin 232 on a housing 2311.

FIG. 9 shows an electrical connector 141 that has sockets 142 for connecting to the connector in FIG. 8.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A heating apparatus, comprising:
a bottom platform with a heating surface;
a bottom heater for heating the heating surface;
a first temperature sensor disposed for detecting a first temperature of the heating surface;
a second temperature sensor disposed on a probe for detecting a second temperature of a food in a container heated by the bottom heater;
a power source for providing a first driving current to the bottom heater to generate heat;
a controller coupled to the power source, the first temperature sensor and the second temperature sensor for determining the first driving current supplied to the bottom heater.

2. The heating apparatus of claim 1, wherein the probe is connected with a wire for transmitting a detected temperature of the second temperature sensor to the controller, wherein the probe is placed within food in the container to detect food temperature.

3. The heating apparatus of claim 1, wherein a container cover corresponding to the container has a hole for inserting and fixing the probe to keep the probe stay within the food.

4. The heating apparatus of claim 1, further comprising a lateral heater and a surrounding wall, wherein the lateral heater heats a surrounding wall, wherein the surrounding wall and the heating surface form a container space for storing the container to emit heat from multiple directions, wherein the controller determines a second driving current supplied to the lateral heater to adjust a heating ratio between the lateral heater and the bottom heater.

5. The heating apparatus of claim 4, wherein the lateral heater and the surrounding wall are removably coupled to the bottom platform, wherein when the lateral heater and the surrounding wall are removed from the bottom platform, food is heated above the heating surface in a first mode, wherein when the lateral heater and the surrounding wall are attached to the bottom platform, food is heated by both the lateral heater and the bottom heater in a second mode.

6. The heating apparatus of claim 4, wherein the lateral heater and the bottom heater share the same power source.

7. The heating apparatus of claim 6, further comprising a manual switch for changing a current ratio between the first driving current and the second driving current.

8. The heating apparatus of claim 7, wherein the current ratio between the first driving current and the second driving current are adjusted by reference to a time schedule during cooking.

9. The heating apparatus of claim 4, wherein when the surrounding wall and the lateral heater is detached from the bottom platform, food upon the heating surface has not lateral shielding wall.

10. The heating apparatus of claim 1, further comprising a heat insulation wall, wherein the heat insulation wall prevents heat escape from lateral direction.

11. The heating apparatus of claim 10, wherein the heat insulation wall encloses the lateral heater.

12. The heating apparatus of claim 10, wherein the heat insulation wall has an air path for hot air heated by the bottom heater to stay in the air path for providing heat from lateral side to a container enclosed by the heat insulation wall and the heating surface.

13. The heating apparatus of claim 1, wherein the first temperature sensor is placed below the heating surface.

14. The heating apparatus of claim 1, further comprising a third temperature sensor placed in a different position from the first temperature sensor and the second temperature sensor, wherein the controller uses data of the first temperature sensor, the second temperature sensor and the third temperature to adjust the first driving current and the second driving current over time according to a time schedule.

15. The heating apparatus of claim 1, wherein controller adjusts the first driving current and the second driving current so that a first position of the container has a different temperature than a second position of the container to increase convection.

16. The heating apparatus of claim 1, further comprising a vibrator, wherein the controller selectively activates the vibrator to generate a vibration to the container to shake the food in the container during food heating.

17. The heating apparatus of claim 16, wherein the heating surface is rotated to carry the container to rotate during food heating.

18. The heating apparatus of claim 16, wherein the vibration of the vibrator is more than 20 Hz.

19. The heating apparatus of claim 1, wherein the controller has a wireless interface to connect to a mobile phone for receiving a cook parameter from the mobile phone, wherein the wireless interface is an HTTP server.

20. The heating apparatus of claim 19, wherein a QR code label is attached to the heating apparatus, wherein the mobile phone scans the QR code label to connect to a remote server with a parameter of the heating apparatus, wherein the remote server receives a photo taken by the mobile phone for a food being cooked in the container, and transmitting a cooking parameter associated with the food in the photo to the mobile phone, wherein the mobile phone further transmits the cooking parameter to the controller to adjust the first driving current of the bottom heater.
